(19) United States
(12) Patent Application Publication
(10) Pub. No.: US 2004/0145200 A1
(43) Pub. Date: Jul. 29, 2004

(54) Padded tweezers

(76) Inventor: Yong Hoon Cho, Fullerton, CA (US)

Correspondence Address: Maria Erlinda C. Sarno, Esq., P.O. Box 1023, Artesia, CA, 90702, US

(21) Appl. No.: 10/351,165

(22) Filed: Jan. 24, 2003

(51) Int. Cl. B25B 9/02

(52) U.S. Cl. 294/99.2

(57) ABSTRACT

A tweezers with a soft and resilient pad on each pincer to provide comfort as well as prevent corns and callouses from forming on the fingers. The touching pad may be installed directly to the pincers by squeezing the tail portion of the touching pad into a hole bored on the pincers. The touching pad may also be supported by a touching pad holder inserted into each pincer of the tweezers. The touching pad holder is held to the pincers by squeezing a tail portion of the touching pad into a hole bored on the pincers. The touching pad can also be installed on the pincers by sliding a touching pad holder having a planar touching pad into each pincers through the L-shaped claws of the touching pad holder until the L-shaped claws snugly engages with the pincers.

### BACKGROUND

This invention relates to a tweezers having a finger touching pad for better grip and comfortable handling.

Current tweezers in the market are made of metal which press upon the fingers. For persons who constantly and repeatedly use tweezers as part of their job, such as beauticians or seamstresses, the constant pressure from the handling of the tweezers can eventually cause formation of callouses and corns on the affected areas of the fingers. If the use of the tweezers demand precision such as in the microbiology, medical and electronic fields, the smooth metallic surface can cause unwanted slippage or drifting of the fingers that can damage or ruin the desired result in addition to the eventual formation of callouses mentioned above. Sweat, moisture, lotion or moisturizers on the fingers aggravates the situation.

U.S. Pat. No. 5,190,335 is directed towards a control enhancing tweezers. While this device may have enhanced the control of the tweezers, the tweezers arm engaging members which incorporates a finger/thumb receiving and holding platform at its respective tips, surrounds almost three quarters of the body of the tweezers except the moving arms which consequently offer resistance when the moving arms are pinched for closure. The device of this invention is specially designed for individuals with reduced or impaired manual dexterity where some resistance to the free movement of the tweezers arms or pincers are desired as well as having more surface area around the body of the tweezers to grab on. If the moving arm is easily moved, one with impaired dexterity will have difficulty at targeting the object desired for picking or plucking. The tweezers also requires more material and more complex molding because the tweezers engaging members must snugly envelope around the body of the tweezers. Further, since the tweezers engaging member extends to the finger/thumb receiving and holding platform as a single piece, the platform should be made of the same material as the engaging members. Because the tweezers engaging members need to be rigid to support the body of the tweezers, the finger/thumb receiving and holding platforms are consequently, also rigid in structure. To provide the grip, the surface of the platform is concave in shape to receive the respective finger. Although this has a concave surface, because it is rigid, the repeated use of this tweezers pose the same problem as the current tweezers in that callouses and corns can potentially form upon repeated usage because the surface that the fingers press on is rigid and hard and the rim protruding around the periphery of the receiving platform accentuates the pressure exerted on the fingers.

It is the object of this invention to provide a tweezers with soft padded surfaces to provide comfortable handling and prevent the formation of corns and callouses on the fingers.

It is also an object of this invention to provide a pad of such materials that will enhance the grip on the device.

It is a further object of the invention to provide a tweezers with a finger touching pad that does not envelope the body of the tweezers thereby not affecting the free movement of the pincers.

It is still a further object of the invention to provide a padded tweezers that is easy to manufacture.

### BRIEF DESCRIPTION OF THE DRAWING

FIG. 1 is a perspective view of the padded tweezers.

FIG. 2 shows the tweezers with a touching pad holder positioned relative to hole bored at the moving end of the body.

FIG. 3 is a perspective view of the touching pad holder.

FIG. 4 is a side view of the touching pad.

FIG. 5 is an alternate touching pad holder.

FIG. 6 is a perspective view of the touching pad for the pad holder of FIG. 5.

FIG. 7 is a perspective view of the padded tweezers using the pad holder of FIG. 5.

FIG. 8 is a perspective view of the padded tweezers without a pad holder.

### SUMMARY OF THE INVENTION

This invention relates to a tweezers with finger touching pads on each pincer to improve the grip and prevent formation of callouses and corns. The tweezers comprise of a body having two pincers with a stationary end and a moving end and a soft and resilient touching pad for each pincer usually supported by a touching pad holder. The touching pad holders are introduced into the pincers at a location on the moving end of the tweezers. This location is the position on the pincers that a user usually squeeze on to close the tweezers. The touching pad can be installed into the pincers either by one end of the touching pad plugging into a hole bored on the moving end of the pincer or by L-shaped claws on a touching pad holder engaging on the moving end of the pincers. The touching pad holder can either have a front and end slits formed by an upper band having a peripheral contour bordering an open space and a lower band joined to the upper band at each lateral end with a strip having a height corresponding to the thickness of the pincers or have a top band having an inside and an outside peripheral contour bordering an open space similar to the touching pad holder with slits above and two lateral sides having an outside lateral surface corresponding to the shape of the top band and an inside lateral surface conforming to the contour of the pincers, the two lateral sides extending downward forming an overhang, each overhang having a tip extending inward to form an L-shaped claw through which the pincer is introduced. One way of forming the L-shaped claw is to cut out a center portion of the lower band of the touching pad holder described above. When the lower band is a whole piece, it forms a slit after connection with the upper band but when it is cut out at the center, it forms an L-shaped claw connecting to the upper or in this description, the top band. The connecting strip or overhang has an outside lateral surface corresponding to the shape of the upper band or top band and an inside lateral surface conforming to the contour of the pincers with its width conforming to the width of the pincers at the point where the touching pad holder sits stationarily on the pincers. For the tweezers having a hole on the pincers through which the touching pad inserts into to hold the touching pad, the touching pad should have a head portion, a tail portion and a stem connecting the head portion with the tail portion. Here, the head portion matches the inside peripheral contour of the upper band of the touching pad holder to fill the open space bordered by the upper band of the touching pad holder and has an ergonomically shaped top surface to provide comfort for the fingers. The stem of the touching pad has a height matching the thickness of the pincers to prevent the movement of the touching pad when the tail portion of the touching pad is inserted into the hole of the pincer. The tail portion of the touching pad has a front end matching the size and shape of the hole bored on the moving end of the pincers and a rear end slightly larger than the front end and the stem to allow the tail portion to act as a one way plug and prevent the touching pad from dislodging after insertion into the hole. The touching pad described can also be installed directly into the holes on the pincers by squeezing the tail portion of the touching pad into the hole to situate and expose the head portion of the touching pad above the outside surface of the pincers. A touching pad can be installed on tweezers without a hole bored on the pincers such as the present tweezers on the market. This is done by using the touching pad holder having the L-shaped claws for engaging into the moving end of the pincers. A suitable touching pad for this has a planar body with an ergonomically shaped top surface to accommodate the fingers and laterally protruding lips along its periphery extending farther than the inside peripheral contour of the top band of the touching pad holder with the L-shaped claws. The protruding lip lodges against the bottom surface of the top band. The planar body of the touching pad also fills the open space bordered by the top band of the touching pad holder. Because the touching pad here does not physically connect with the pincers unlike the touching pad with a tail squeezing into the holes of the pincers, the touching pad holder supporting the touching pad may be glued to the pincers for reinforcement. A vital feature of this invention is the touching pad protruding from the top surface of either the pincers or the upper or top band of the touching pad holder to prevent the fingers from pressing into a hard surface.

A method for assembling a padded tweezers with a hole bored on each pincer at a location where a touching pad is desired, comprises inserting into each moving end of the pincer through a front and a back slit of a touching pad holder having an upper band bordering an open space and a lower band joined to the upper band at each lateral end with a strip having a height corresponding to the thickness of the pincers forming the slits until the touching pad holder stops advancing, at a point when the hole is exposed at the center of the open space bordered by the upper band of the touching pad holder; and, installing the touching pad having a head portion, a tail portion and a stem portion connecting the head portion with the tail portion, into the touching pad holder by entering the tail portion through the upper band of the touching pad holder and squeezing the tail portion into the hole exposed at the center of the open space bordered by the upper band of the touching pad holder thereby situating the touching pad holder on the pincer and exposing the head portion of the touching pad above the upper band of the touching pad holder.

For tweezers without a hole bored on the pincers, the method of assembling the padded tweezers, comprises installing a touching pad having a planar body with an ergonomically shaped top surface and laterally protruding lip along its periphery into a touching pad holder having a top band bordering an open space and L-shaped claws extending downward from two lateral sides of the touching pad holder by slipping the top surface of the touching pad from under the top band of the touching pad holder through the open space and protruding the top surface of the touching pad above the top band of the touching pad holder; and, inserting the touching pad holder having the touching pad into each pincer of the tweezers through the L-shaped claws until the L-shaped claws fits snugly on the pincers. The touching pad holder may be glued to the pincers for reinforcement if desired.

### DETAILED DESCRIPTION OF THE INVENTION

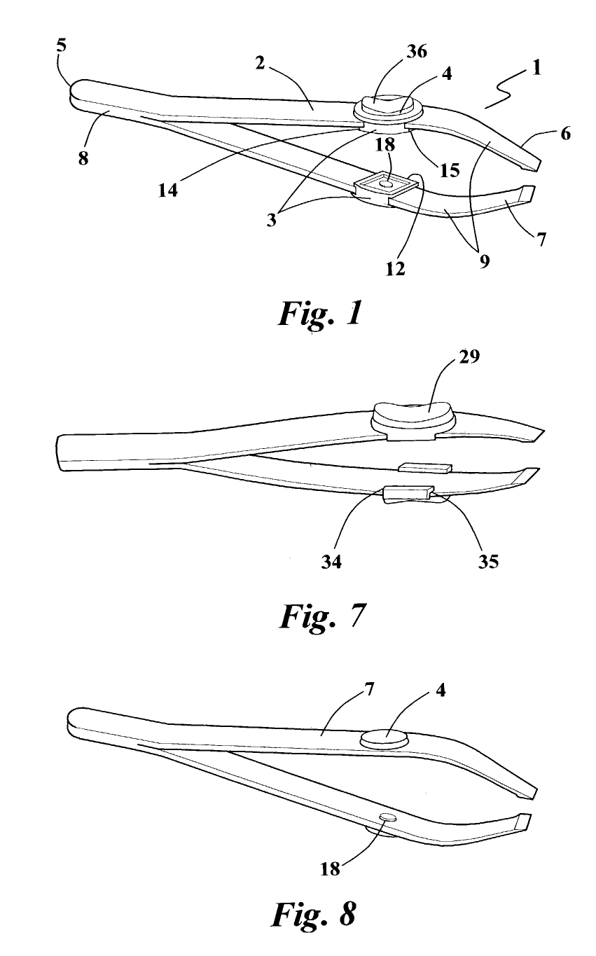

The invention relates to a tweezers 1 with a finger touching pad to provide comfort to the fingers, usually the forefinger and thumb as they press into the pincers or moving arm of the device. FIGS. 1, 7 and 8 shows the perspective view of the padded tweezers. It is simple in construction and is made up of the body 2, the finger touching pad 4 and a touching pad holder 3, if desired. The body 2 of the tweezers has a distal end 5 and a proximal end 6. The tweezers has two pincers or arms 7 fused together on the distal end 5 to form a stationary end 8 and a moving end 9 at the proximal end 6.

The invention herein proposes three general methods of padding a tweezers. Two of the methods require boring a hole 10 on each moving end 9 of the tweezers where the finger touching pad 4 will be installed. The other method does not need a hole bored on the pincers 7 of the tweezers. However, all these methods result in basically the same padded tweezers as shown in FIGS. 1, 7 and 8.

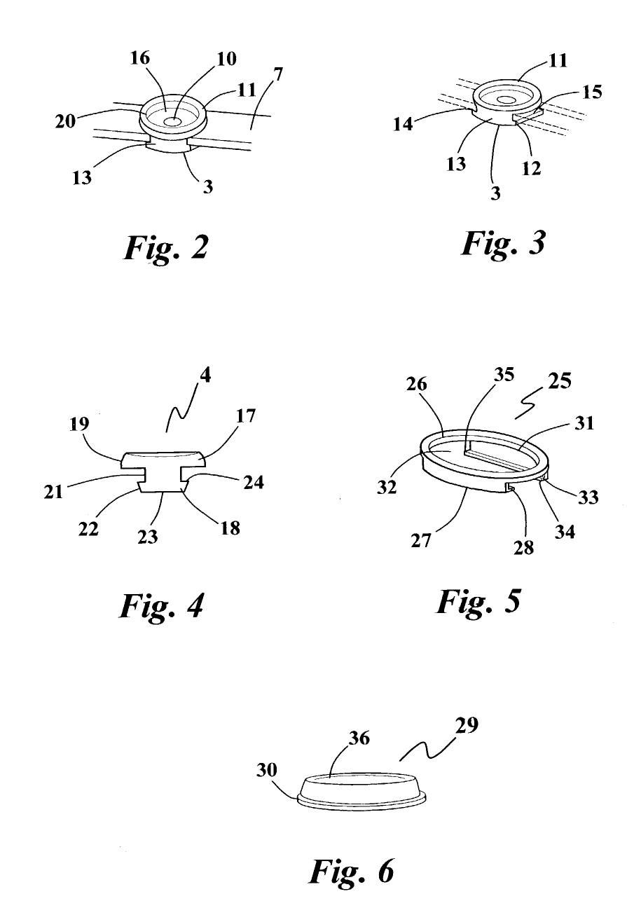

On the method requiring a hole 10 on the moving end of the tweezers, a touching pad holder 3 is slipped into each pincer or arm 7 of the tweezers 1 as shown in FIGS. 1 and 2. The touching pad holder 3 of this method as shown in FIGS. 2 and 3 has an upper band 11 preferably oval or rounded in shape and a lower band 12 joined at each lateral end with a strip 13 having a height corresponding to the thickness of the pincers 7. The outside lateral surface of the strip correspond to the shape of the lateral end of the upper band 11. If the upper band is oval or rounded, the outside lateral surface of the strip is curved accordingly. The inside lateral surface conforms to the contour of the pincer, herein shown as tapering. The lower band 12 need not be oval in shape but it can be any geometric shape so long as the upper 11 and lower 12 band joined and bordered by the lateral strips 13 forms a slit through which a moving arm or pincer 7 can be introduced. The width of the slits may differ in size if for example, the width of the pincers 7 tapers towards the proximal tip. In a tapering pincer, the front slit 14 through which the pincer 7 enters is wider than the back slit 15 of the touching pad holder 3. It is constructed this way so that the touching pad holder 3 stops advancing towards the stationary end 8 of the tweezers when the width of the front slit 14 matches the width of the pincer. At this position, the narrower width of the back slit 15 should also matches the narrower width of the pincer to allow the touching pad holder to snugly engage on the pincer. For the tweezers having a hole on the moving end of the pincers, the touching pad holder 3 should stop advancing when the hole 10 is at the center of the open space bordered by the upper band 11 as shown in FIG. 2.

After lodging both touching pad holders 3 on the respective pincers 7, a touching pad 4 that is soft and resilient complimenting the characteristics of the human finger, is introduced into the hole 10 to fill the open space 16 bordered by the upper band 11 as shown in FIGS. 1 and 2. FIG. 4 shows the side view of the touching pad 4. It has a head 17 portion and a tail 18 portion. The peripheral contour 19 of the head portion 17 matches the inside peripheral contour 20 of the upper band 11 of the touching pad holder 3. The head 17 portion is connected to the tail 18 portion by a stem 21 matching the shape of the hole 10. The height of the stem matches the thickness of the pincer 7. The tail 18 portion preferably has tapering side walls 22 to facilitate the introduction of the touching pad 4 into the hole 10. The surface area of the front end 23 of the tail portion matches the size and shape of the hole but the rear end 24 of the tail 18 portion is slightly larger than the front end 23 and the stem 21 so that the tail 18 acts as a one way plug to prevent the touching pad 4 from dislodging after it has been introduced into the hole. The touching pad 4 also prevents the touching pad holder 3 from moving or sliding from its position on the pincer. While the hole herein is shown as circular in shape, any geometric shape can be used so long as the tail and stem of the touching pad matches the shape of the hole. Also, while the head of the touching pad herein is shown as oval in shape, other geometric shapes can also be used so long as its contour matches the contour of the upper band 11 or top band 26 of the touching pad holder. Further, while it is demonstrated here that a touching pad holder supports the touching pad installed into the pincers of the tweezers, it is also possible to install the touching pad 4 directly into the pincers 7 by squeezing the tail 18 of the touching pad into the hole 10 absent any touching pad holder as shown in FIG. 8.

An alternate touching pad holder 25 is shown in FIG. 5. Current tweezers do not need to be modified, that is, holes bored to adopt this holder. This pad holder 25 has a top band 26 like the pad holder illustrated above. However, instead of a lower band, the lateral sides of the touching pad holder extends downward to form an overhang 27 as shown in FIG. 5. The tip of the two overhang extends inward to form an L-shaped claw 28 where the pincer of the tweezers rests once the touching pad holder 25 is inserted into each pincer of the tweezers 1. Comparing the touching pad holders shown in FIGS. 3 and 5, it is apparent that the touching pad holder shown in FIG. 5 merely cut out a center portion of the lower band of the touching pad holder shown in FIG. 3. Because there is no need of a hole in each pincer, the touching pad 29 for this type of holder does not have a stem portion. Rather, the touching pad 29 has a planar body with an ergonomically shaped top surface, having a laterally protruding lip 30 along its periphery as shown in FIG. 6. To install the touching pad into this holder 25, the touching pad 29 is first inserted from the bottom into the touching pad holder 25. The absence of the lower band in this pad holder facilitates the insertion. The lip 30 of the touching pad extends farther than the inside peripheral contour of the top band, thereby lodging against the bottom surface 31 of the top band 26. Like the above pad holder, the touching pad fills the open space 32 bordered by the top band 26. Once the pad 29 is engaged with the pad holder 25, the pad holder is inserted into each pincer through the L-shaped claw 28 opening at each end 33 of the touching pad holder 25. The pincers keep the touching pad from getting out of the touching pad holder because the inserted pincers situate underneath the bottom surface of the touching pad. If the tweezers has a tapering pincer 7, like the other holder, the front end claw 34 has a wider span than the back end claw 35. This touching pad assembly, that is, pad inside the pad holder, also stops sliding towards the stationary end of the tweezers when the width span of the front end claw matches the width of the pincer. The touching pad assembly can simply be held on the pincers by friction but to ensure that the touching pad assembly does not move, it is preferably glued to the pincer for reinforcement.

Regardless of what method is used to pad the tweezers, the pad 4 or 29 protrudes from the top surface of the top band 11 or 26 as shown in FIGS. 1 and 7 or the pincers 7 as shown in FIG. 8 so that a user will not feel any hard surface such as the top or upper band when the fingers press on the touching pad unlike that claimed in U.S. Pat. No. 5,190,335 where the rim of the finger receiving platform presses on the fingers. Because here, the fingers only encounter the soft and resilient pad, the formation of corns and callouses are prevented. Examples of materials that can be used to make the touching pad are, rubber based material, silicone, and gel. For the latter, the top surface 36 of the touching pad need not be shaped to ergonomically accommodate the fingers because the gel will naturally acquire the shape of the fingers. However, for the non-gel but soft and resilient material such as latex and silicone, the top surface 36 is usually concave to fit the surface of the fingers. For surgical usage, the pad 4 or 29 are preferably made of materials that can be sterilized.

The above invention is usually used by the thumb and forefingers pressing on the touching pad when it pinches on an object for transfer, removal, placement or plucking.

The touching pads on both touching pad holders described above may be replaced when it gets worn out with usage or gets a dirty appearance by simply detaching the touching pad from the hole on the pincers or in the touching pad holder with L-shaped claws, slipping the touching pad holder out of the pincers and replacing the touching pad.

While the embodiment of the present invention has been described, it should be understood that various changes, modifications and adaptations may be made therein without departing from the spirit of the invention and the scope of the appended claims. Those skilled in the art will recognize that other and further variations of the features presented herein are possible. The scope of the present invention should be determined by the teachings disclosed herein, the appended claims and their legal equivalents.

I claim:

1. A tweezers with finger touching pads on each pincer to improve the grip and prevent formation of callouses and corns, comprising:
a body having two pincers with a stationary end and a moving end; and,
a touching pad holder accommodating a soft and resilient touching pad for each pincer, the touching pad holders introduced into the pincers at a location on the moving end of the tweezers.

2. The tweezers of claim 1 wherein the touching pad holder is attached to the pincers by one end of the touching pad plugging into a hole bored on the moving end of the pincers.

3. The tweezers of claim 1 wherein the touching pad holder is attached to the pincers by L-shaped claws on the touching pad holder engaging on the moving end of the pincers.

4. The tweezers of claim 1 wherein the touching pad holder accommodating the touching pad has an upper band bordering an open space and a lower band joined to the upper band at each lateral end with a strip having a height corresponding to the thickness of the pincers thereby forming a front slit and a back slit through which the moving end of the pincers is introduced.

5. The tweezers of claim 4 wherein the connecting strip has an outside lateral surface corresponding to the shape of the upper band and an inside lateral surface conforming to the contour of the pincers.

6. The tweezers of claim 4 wherein the slits of the touching pad holder conform to the width of the pincers at a point where the touching pad holder sits stationarily on the pincers.

7. The tweezers of claim 4 wherein the touching pad fills an open space bordered by the upper band.

8. The tweezers of claim 1 wherein the touching pad has a head portion, a tail portion and a stem connecting the head portion with the tail portion.

9. The tweezers of claim 8 wherein the head portion of the touching pad matches an inside peripheral contour of an upper band of the touching pad holder.

10. The tweezers of claim 8 wherein the stem of the touching pad has a height matching the thickness of the pincers.

11. The tweezers of claim 8 wherein the tail portion of the touching pad has a front end matching the size and shape of a hole bored on the moving end of the pincers, a rear end slightly larger than the front end and the stem, the tail portion acting as a one way plug to prevent the touching pad from dislodging after insertion of the tail portion into the hole.

12. The tweezers of claim 1 wherein the touching pad holder has a top band having an inside and an outside peripheral contour bordering an open space, two lateral sides having an outside lateral surface corresponding to the shape of the top band and an inside lateral surface conforming to the contour of the pincers, the two lateral sides extending downward forming an overhang, each overhang having a tip extending inward to form an L-shaped claw through which the pincer is introduced, the L-shaped claw snugly keeping the touching pad holder attached to the pincers.

13. The tweezers of claim 12 wherein the touching pad has a planar body with an ergonomically shaped top surface to accommodate the fingers and laterally protruding lip along its periphery extending farther than the inside peripheral contour of the top band thereby lodging against the bottom surface of the top band, the touching pad filling an open space bordered by the top band of the touching pad holder.

14. The tweezers of claim 1 wherein the touching pad holder is glued to the pincers.

15. The tweezers of claim 1 wherein the touching pad protrudes from the top surface of the touching pad holder to prevent the fingers from pressing on the touching pad holder.

16. The tweezers of claim 1 wherein the touching pad has an ergonomically shaped top surface to provide comfort for the fingers.

17. A method for assembling a padded tweezers, comprising:
boring a hole on each pincer at a location where a touching pad is desired;
inserting into each moving end of the pincer a touching pad holder through a front and a back slit of the touching pad holder having an upper band bordering an open space and a lower band joined to the upper band at each lateral end by a strip having a height corresponding to the thickness of the pincers, until the touching pad holder stops advancing at a point when the hole is exposed on the center of the upper band of the touching pad holder; and,
installing the touching pad having a head portion, a tail portion and a stem portion connecting the head portion with the tail portion, into the touching pad holder by entering the tail portion through the upper band of the touching pad holder and squeezing the tail portion into the hole exposed on the center of the upper band of the touching pad holder thereby situating the touching pad holder on the pincer and exposing the head portion of the touching pad above the upper band of the touching pad holder.

18. A method for assembling a padded tweezers without a hole bored on the pincers, comprising:
installing a touching pad having a planar body with an ergonomically shaped top surface and laterally protruding lip along its periphery into a touching pad holder having a top band bordering an open space and L-shaped claws extending downward from two lateral sides of the touching pad holder by slipping the top surface of the touching pad from under the top band of the touching pad holder through the open space and protruding the top surface of the touching pad above the top band of the touching pad holder; and,
inserting the touching pad holder having the touching pad into each pincer of the tweezers through the L-shaped claws until the L-shaped claws fits snugly on the pincers.

19. The method of claim 18 further comprising the step of gluing the touching pad holder having the touching pad into the pincers.

20. A tweezers with finger touching pads on each pincer to improve the grip and prevent formation of callouses and corns, comprising:
a body having two pincers with a stationary end and a moving end, the two pincers having a hole bored at a location on the moving end where a touching pad is desired; and,
a soft and resilient touching pad having a head portion with an ergonomically shaped top surface exposed on the outside surface of the pincers above the hole on each moving end of the pincers.

21. A method for assembling a tweezers having a soft and resilient touching pad inserted into a moving end of each pincers, comprising:
boring a hole on each pincer at a location where a touching pad is desired; and,
installing the touching pad having a head portion, a tail portion and a stem portion connecting the head portion with the tail portion into an outside surface of each pincer by squeezing the tail portion into the hole on the pincer to situate and expose the head portion of the touching pad above the outside surface of the pincers, the stem portion having a height the same as the thickness of the pincers thereby preventing movement of the touching pad.
